(19) United States
(12) Patent Application Publication
(10) Pub. No.: US 2025/0237107 A1
(43) Pub. Date: Jul. 24, 2025

(54) SECURITY SCREEN SYSTEM AND METHOD OF AUTOMATED OR SEMI-AUTOMATED ASSEMBLY

(71) Applicant: Meshtec International Co., Ltd., Chiang Mai (TH)

(72) Inventors: David Neil Edlin, Chiang Mai (TH); Peter Syme Taylor, New Farm (AU); Jiradet Krutthai, Chiang Mai (TH)

(21) Appl. No.: 19/028,906

(22) Filed: Jan. 17, 2025

Related U.S. Application Data
(60) Provisional application No. 63/623,492, filed on Jan. 22, 2024.

(51) Int. Cl. E06B 9/01; E06B 9/52

(52) U.S. Cl. CPC E06B 9/01; E06B 9/52; E06B 2009/527

(57) ABSTRACT

There is provided a screen system. The system may include frame assemblies defining a frame, and a sheet of infill material secured to the frame. One or more of the frame assemblies may include: an outer sash including a first sidewall, a second sidewall, and first engagement member(s), with the first sidewall including a retaining portion; a cover sash including second engagement member(s) configured to engage the first engagement member(s) such that the cover sash occupies a position opposing the retaining portion of the first sidewall and, in combination with the retaining portion, defines a channel therebetween; and an inner sash disposed in the channel between the retaining portion and the cover sash, the inner sash configured to retain an end of the sheet of infill material. There is also provided a method of assembly.

### CROSS-REFERENCE TO RELATED APPLICATION(S)

This application claims the benefit of and priority to U.S. Application No. 63/623,492, filed Jan. 22, 2024, which is incorporated by reference herein in its entirety.

### FIELD

The present application relates to security screen systems, and more particularly, to security screen systems involving mesh and/or other infill secured in a frame.

### BACKGROUND

Security screen systems are available for doors and windows. These systems generally involve securing a mesh, or other infill material, within a frame by use of certain fasteners. An inherent issue with security screens is around securing, fixing, or fastening the mesh or other infill into the door or window frame with a fixing system that is both strong and secure enough to either meet or exceed current standards. Current fasteners typically involve variations on a theme of screws, rivets, wedges, tape, glue, or a combination thereof, to secure the infill within the frame.

However, an issue generally with these security screen systems is that they are time-consuming and laborious to manufacture. They typically require manual construction for a large part of the assembly process, which increases both manufacturing time and costs. There is therefore a need for security screen systems that use fasteners that would allow the security screen to be manufactured and assembled by an automated, or at least semi-automated, process. There is a need for a security screen system that is less expensive, quicker, and easier to assemble than current systems.

Accordingly, it would be desirable to have a security screen system that satisfies, at least, two objectives. First, it should provide a secure fixing arrangement that meets or exceeds current standards. Second, it would preferably use fasteners that enable the security screen to be manufactured and assembled by an automated or semi-automated process. In other words, it would be desirable to develop a security system that both meets or exceeds the current standards where manufacture and assembly could be performed by automated or semi-automated processes to reduce the labor-intensive nature of assembly.

### BRIEF DESCRIPTION OF THE DRAWINGS

FIG. 1 is a perspective view of a screen system including a mesh (and/or other infill) and a frame;

FIG. 2 is a cross-sectional view of an assembled first frame assembly of FIG. 1 connecting the mesh (and/or other infill) and the frame;

FIG. 3 shows a cross-sectional view of the outer sash of the first frame assembly of FIG. 2;

FIG. 4 shows a cross-sectional view of the inner sash of the first frame assembly of FIG. 2;

FIG. 5 shows a cross-sectional view of the cover sash of the first frame assembly of FIG. 2;

FIG. 6 shows a cross-sectional view of the wedge of the first frame assembly of FIG. 2;

FIG. 7 shows a cross-sectional view of the wedge seal of the first frame assembly of FIG. 2;

FIGS. 8A, 8B, 8C, 8D, 8E, 8F, and 8G show cross-sectional views of the first frame assembly of FIG. 2 at various stages, and corresponding steps, of assembly;

FIGS. 9A, 9B, 9C, 9D, 9E, 9F, and 9G show perspective views of the screen system of FIG. 1 at the various stages and steps of assembly corresponding to FIGS. 8A, 8B, 8C, 8D, 8E, 8F, and 8G, respectively;

FIGS. 10A, 10B, 10C, 10D, 10E, 10F, and 10G show cross-sectional views of a second frame assembly at various stages and steps of assembly; and

FIGS. 11A, 11B, 11C, 11D, 11E, and 11F show cross-sectional views of a third frame assembly at various stages and steps of assembly.

### DETAILED DESCRIPTION

This disclosure has application to a security screen system for doors and windows of buildings, including domestic residences. For illustrative purposes, reference may be made to such applications. However, it is to be understood that this disclosure also has other applications, such as, for example, fencing and balustrade systems, insect screens for doors and windows, screens for covering openings vents, walls or partitions for structures, or any other application where a mesh screen or interface is desirable.

The following description is not to be taken in a limiting sense but is made merely for the purpose of describing the general principles of exemplary embodiments. Reference throughout this specification to “one form,” “one embodiment,” “an embodiment,” “some embodiments”, “an implementation”, “some implementations”, “some applications”, or similar language means that a particular feature, structure, or characteristic described in connection with the embodiment is included in at least one embodiment of the present disclosure. Thus, appearances of the phrases “in one embodiment,” “in an embodiment,” “in some embodiments”, “in some implementations”, and similar language throughout this specification do not all refer to the same embodiment.

The terms “top” and “bottom,” “upper” and “lower” and “vertical” and “horizontal as may be used herein are by way of example and illustrative purposes only and are not meant to limit the description of the embodiments inasmuch as the referenced item can be exchanged in position and orientation. Also, as used herein, the terms “substantially” and/or “about” mean that the specified dimension or parameter may be varied within an acceptable manufacturing tolerance for a given application.

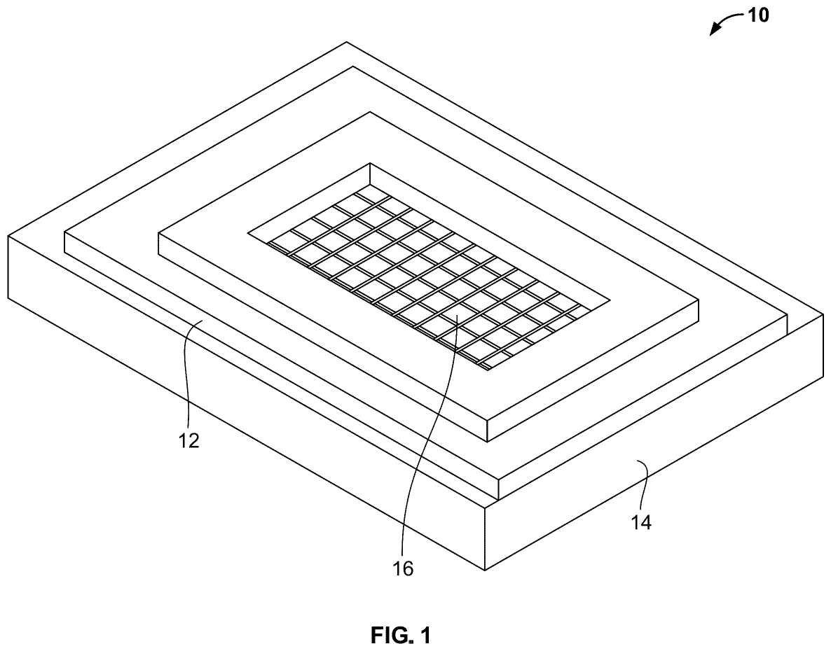

FIG. 1 shows a security screen system 10 that includes a rectangular frame 12 (or sash) composed of multiple frame assemblies 14 (in this case, four frame assemblies). The frame assemblies 14 define an opening that is occupied by a mesh/infill screen or sheet 16. The rectangular frame extends about and supports the mesh/infill screen or sheet 16. The material of the mesh/infill screen 16 may be any of various types of infill materials, such as, for example, stainless steel wire, a perforated metal sheet, insect resistant fabric, etc. The frame assemblies 14 are typically aluminum channels with a variety of internal structures. The edges of the mesh/infill screen or sheet 16 are fastened within the frame assemblies 14, which are in turn joined to one another at the corners of the frame 12. Details of various embodiments of frames, frame assemblies, mesh/infill screens, and other aspects of security screen systems are described, for example, in U.S. Pat. Nos. 6,802,357, 8,191,606, and U.S. Application No. 63/528,233, which are incorporated by reference herein in their entirety.

At a high level, this disclosure generally involves a fastening system with fastening assemblies for use in holding and maintaining the mesh (or infill) in the security screens. Each fastening assembly generally includes various components for holding and securing the mesh/infill. In one aspect, this fastening system employs a “bung system,” which employs one or more wedges driven or pulled into the profile to help secure the mesh. It is generally contemplated that, in one form, these components may be assembled using an automated or semi-automated process and machinery. It should be understood that the terms “mesh” and “infill” are used broadly in this disclosure. The term “infill” is intended broadly to refer to any sort of sheet-like or other material that can be used in the systems and methods described herein.

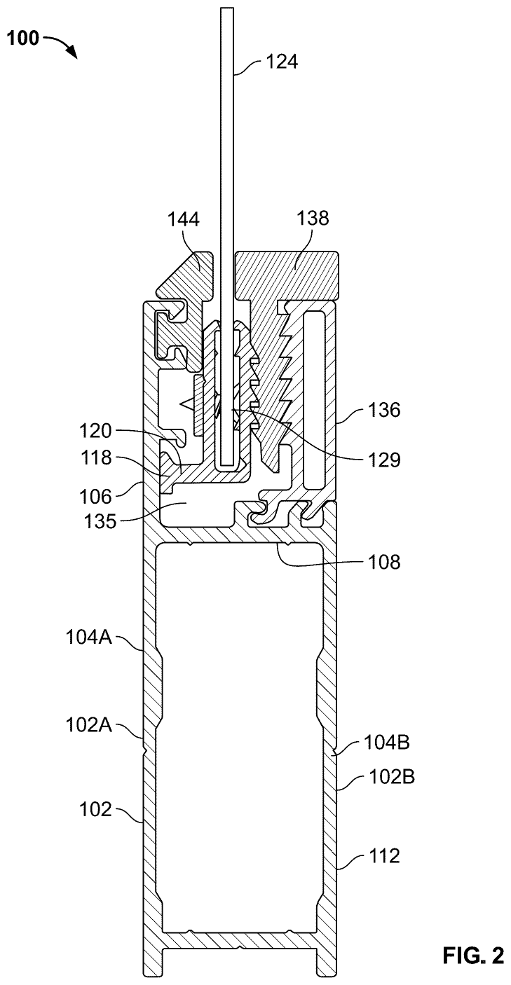

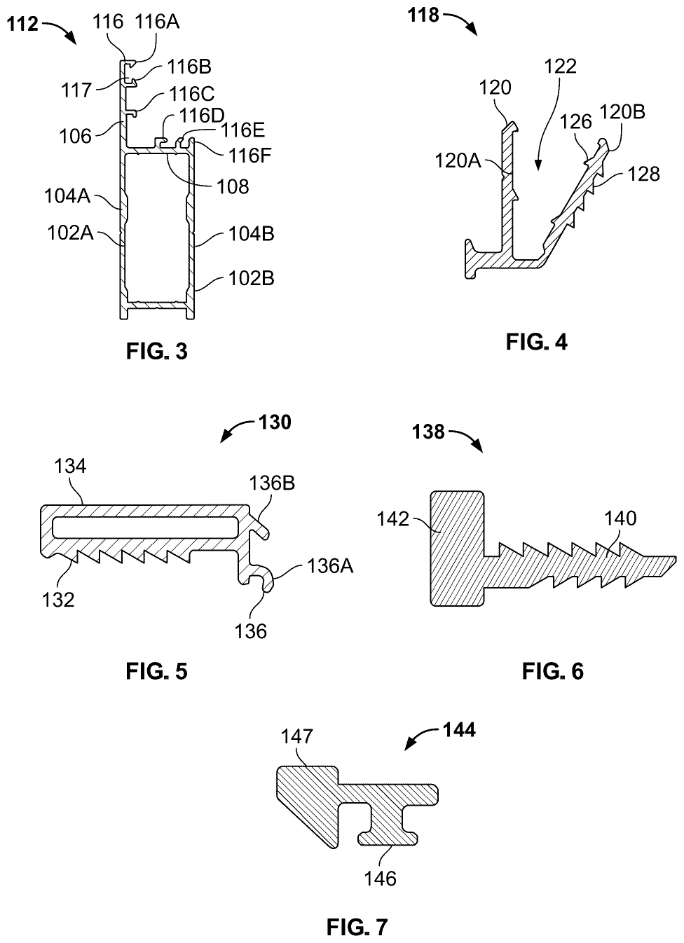

FIGS. 2-7 show a first embodiment of a frame assembly 100, which generally illustrates a wedge with stopper concept. FIG. 2 shows the frame assembly 100 in an assembled condition. In one form, the frame assembly 100 includes an outer sash 112 that includes two opposing sidewalls 102 that are generally parallel to one another. A first sidewall 102A preferably has a base portion 104A and a retaining portion 106 separated by a dividing wall 108. In contrast, a second sidewall 102B preferably has a base portion 104B but does not include a retaining portion. Instead, the outer sash 112 is open on this second side to allow the insertion and reception of other components, as addressed below. This open second side facilitates the use of machinery for automated or semi-automated assembly. So, in this form, as shown in FIGS. 2 and 3, the top (or inner) part of the outer sash 112 is preferably L-shaped.

FIG. 3 shows the outer sash 112 prior to assembly. In one form, the outer sash 112 may be composed of aluminum material, although other materials may also be used. As can be seen, in this form, the L-shaped top part may include several engagement members 116 protruding into the interior. For example, the top part may include two engagement members 116A and 116B that engage and help retain a first wedge (or wedge seal) 144 following assembly. In one form, these two engagement members 116A and 116B may be hooked/barbed, they may be disposed on the retaining portion 106 of the first sidewall 102A, and the hooked portions may face one another. The two engagement members 116A and 116B may define a slot 117 therebetween for receiving the wedge seal 144.

Additionally, the top part may include a third engagement member 116C that is adjacent to and help retain an inner sash 118 following assembly. In one form, this third engagement member 116C may be hooked/barbed and may be disposed on the retaining portion 106 below the first two engagement members 116A and 116B. Further, the top part may include three additional engagement members 116D, 116E, and 116F that may engage and help retain a cover sash 130 following assembly. In one form, one or more of these three engagement members 116D, 116E, and 116F may be hooked/barbed, and they may be disposed on the dividing wall 108. In some forms, some of these engagement members 116 need not be used, and some or all of these engagement members 116 may use different shapes for retention of various components, i.e., they are not necessarily hooked or barbed.

FIG. 4 shows an inner sash 118 prior to assembly. The inner sash 118 is generally configured to be inserted, received within, and retained by the outer sash 112. The inner sash 118 preferably includes three legs 120 (or wings). The inner sash 118 may be composed of aluminum material, although other materials may also be used. Two of the legs 120A and 120B may form a U-shaped channel 122 for receiving an end of the mesh/infill screen or sheet 124 therein. In one form, the two legs 120A and 120B may include one or more inner serrations or teeth 126 on the inner portions to engage and help retain the mesh/infill 124. In one form, one of the two legs 120B also preferably includes outer serrations or teeth 128 on the outer portion of the leg 120B to engage a second wedge (wedge 138). Another leg 120C extends laterally from the bottom of the channel 122 to engage the retaining portion 106 of the outer sash 112. As can be seen in FIG. 2, an end of the mesh/infill 124 is preferably fixed in place within the inner sash 118 by a fastener 129, such as a support screw or rivet.

FIG. 5 shows a cover sash 130 prior to assembly. In one form, the cover sash 130 may be composed of an aluminum material, although other materials may also be used. In one aspect, the cover sash 130 may be used to, in effect, fill in or replace the missing inner portion of the second sidewall 102B of the outer sash 112. The cover sash 130 includes an inner wall 132 (which may be serrated in one form) for engagement with the wedge 138. It also preferably includes an outer wall 134 that, in effect, acts to extend the base portion 104B to form a continuous or extended second sidewall structure following assembly. Further, the cover sash 130 includes engagement members 136 (preferably two hooked/barbed engagement members 136A and 136B) to engage corresponding engagement members 116D, 116E, and 116F of the outer sash 112. In one aspect, when assembled, the cover sash 130 completes the outer boundary or structure of the outer sash 112. When assembled, the cover sash 130, in combination with the retaining portion 106 of the first sidewall 102A, defines a channel 135 in the outer sash 112 in which the inner sash 118 is disposed.

FIG. 6 shows a wedge 138 prior to assembly. In one form, the wedge 138 may be composed of a polyvinyl chloride (PVC) material, although other materials may also be used. The wedge 138 preferably includes a projection 140 (preferably with teeth/serrations on both sides) for engaging the inner sash 118 on one side and the cover sash 130 on an opposite side. The top end of the wedge 138 is preferably in the form of a stopper 142 that transitions into the projection 140. Following assembly, the stopper 142 overlies the cover sash 130 on one side of the mesh/infill 124.

FIG. 7 shows a wedge seal 144 prior to assembly. In one form, the wedge seal 144 may be composed of a polyvinyl chloride (PVC) material, although other materials may also be used. The wedge seal 144 preferably includes a protrusion 146 that is configured to engage and be received by engagement members 116A and 116B of the outer sash 112. In one form following assembly, on one side, the wedge seal 144 engages the outer sash 112, and on the opposite side it engages the inner sash 118. The wedge seal 144 also preferably includes a stopper 147 at a top end that, following assembly, overlies the outer sash 112 on the side of the mesh/infill 124 opposite the wedge 138. The use of one or more stoppers may be desirable to facilitate application of a pushing or pulling force by machinery for insertion components into the outer sash 112.

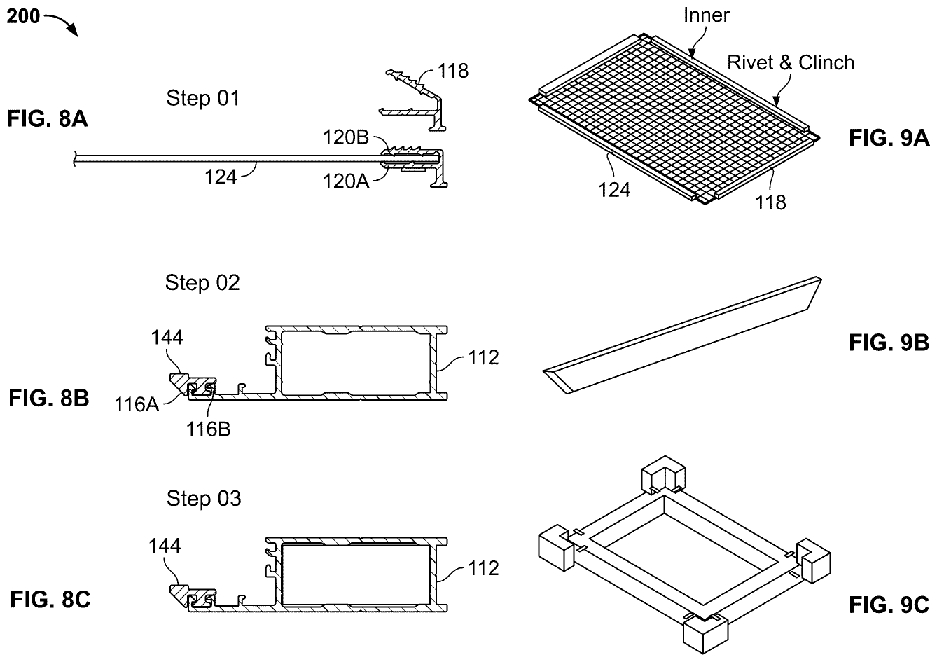

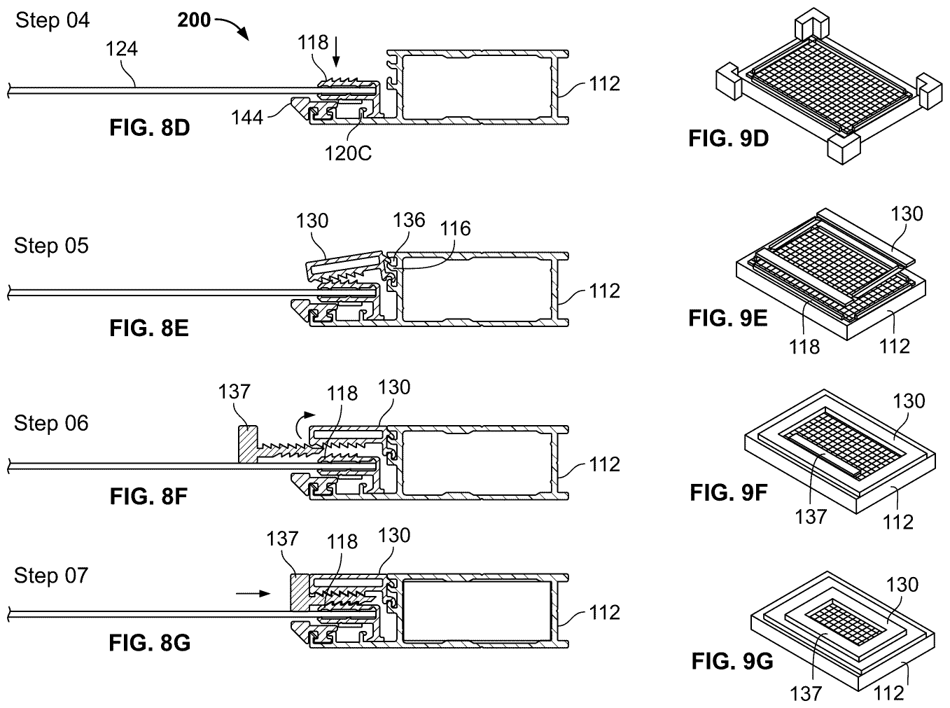

FIGS. 8A, 8B, 8C, 8D, 8E, 8F, and 8G show cross-sectional views of the first frame assembly 100 at various stages, and corresponding steps, of assembly. These figures also collectively illustrate a method 200 of assembly generally including various steps. FIGS. 8A, 8B, 8C, 8D, 8E, 8F, and 8G correspond to the below Steps 1-7, respectively. FIGS. 9A, 9B, 9C, 9D, 9E, 9F, and 9G show perspective views of the screen system 10 at the various stages and steps of assembly corresponding to FIGS. 8A, 8B, 8C, 8D, 8E, 8F, and 8G, respectively.

It is generally contemplated that the method 200 is for assembling the frame assembly 100 and the screen security system 10 described above. The description of the screen security system 10, frame assembly 100, and components thereof are incorporated herein. It is generally contemplated that the components described above may be used in the method 200, and the reference numerals for these components are included below for ease of reference and understanding. However, it should be understood that some or all of the components may be assembled in modified form. Also, it should be understood that, in some forms, these assembly steps may be performed in a different order, some steps may be omitted or modified, and other steps may be added. Further, in one preferred form, it is contemplated that most or all of the steps are conducted by automated or semi-automated assembly. In other forms, however, some of the steps may be performed manually by individuals.

In step 1 (FIG. 8A), a sheet of mesh or infill 124 is obtained. An inner sash 118 then engages the mesh/infill 124 in which two legs 120A and 120B of the inner sash 118 are sandwiched about an end of the mesh/infill 124. In one form, it is contemplated that a robot arm may be used to hold the inner sash 118 in position while the mesh/infill 124 is inserted. A clinch and rivet device (or an individual) may apply a fastener to fasten the inner sash 118 to the end of the mesh/infill 124. In one form, the mesh sheet and inner sash may be placed into position before being fed into an automatic clinching or rivet machine. FIG. 9A shows a perspective view of the combined mesh/infill 124 and inner sash 118 following this assembly step. As can be seen, the inner sash 118 generally extends about the perimeter of the mesh/infill 124.

In step 2 (FIG. 8B), the wedge seal 144 is inserted into and received by the outer sash 112. More specifically, in one preferred form, the wedge seal 144 is inserted into a slot 117 in the outer sash 112 formed by two engagement members 116A and 116B. In one form, it is contemplated that the wedge seal 144 may be formed of PVC (or some plastic material) and that the outer sash 112 may be formed of aluminum (or some other lightweight metal material). FIG. 9B shows a perspective view of a partial frame assembly with the combined wedge seal 144 and outer sash 112 following this assembly step.

In step 3 (FIG. 8C), which is a framing step, four partial frame assemblies have been formed. Adjacent partial frame assemblies are fixed to one another by the use of corner pieces to form a partially-assembled rectangular frame. Corner fixing fasteners may be used to connect a partial frame assembly to an adjacent one. FIG. 9C shows a perspective view of four partial frame assemblies and to be fastened together by corner fixing fasteners with the assistance of four corner pieces.

In step 4 (FIG. 8D), the combined mesh/infill 124 and inner sash 118 (of step 1) is attached to the partially-assembled rectangular frame (of step 3). In one form, it is generally contemplated that the combined mesh/infill 124 and inner sash 118 (of step 1) is attached to the partially-assembled rectangular frame (of step 3). In one form, the manner of attachment may be by pasting, such as, for example, by glue, sealant, tape, or some other adhesive. As can be seen, leg 120C of the inner sash 118 may be disposed adjacent a third engagement member 116C of the outer sash 112. FIG. 9D shows a perspective view of this assembly step in which four inner sash portions 118 generally define a rectangle that is disposed adjacent to and inside of the generally rectangular outer sash 112.

In one preferred form, it is contemplated that this step may be performed in an automated manner using one or more robotic arms. For example, it is contemplated that the rectangular outer sash 112 (partially-assembled rectangular frame) may be clamped into position. One or more robot arms may carry or transfer the combined mesh/infill 124 and inner sash 118 from its station to the outer sash 112 station. Further, in one form, a robot arm with a vacuum cup effector to hold the inner sash 118 may lift and then push the inner sash 118 downwardly to engage the outer sash 112 and wedge seal 144 (although other machinery and devices may also be used). Although an automated approach is contemplated, it should also be understood that this step (and other steps) could be performed manually, such as positioning the combined mesh/infill 124 and inner sash 118 by hand and then tapping down with a tool.

In step 5 (FIG. 8E), the cover sash 130 is positioned for insertion into the outer sash 112. More specifically, in one form, one or more engagement members 136 of the cover sash 130 may be positioned to engage corresponding engagement members 116 of the outer sash 112. In one preferred form, it is contemplated that this step may be performed using a robotic arm with a vacuum cup effector. As can be seen, the cover sash 130 is not quite in the correct position and is angled downwardly against the inner sash 118 following this step. FIG. 9E shows a perspective view of this assembly step in which the cover sash 130 is shown being inserted to overlie the inner sash 118.

In step 6 (FIG. 8F), the tip of the wedge 137 is inserted between the inner sash 118 and the cover sash 130 to cause the cover sash 130 to rotate upwardly. In this manner, the cover sash 130 may be generally moved to its proper position. FIG. 9F shows a perspective view of this assembly step in which the wedge 137 in the form of a strip is shown adjacent to and inside of a portion of the cover sash 130. In one form, it is contemplated that this step may be performed using a robotic arm with a vacuum cup effector.

In step 7 (FIG. 8G), the wedge 137 is inserted (or impacted) into the space between the inner sash 118 and the cover sash 130. It is generally contemplated that the wedge may be pushed or pulled into position. FIG. 9G shows a perspective view of this assembly step in which the wedges 137 generally define a rectangle that is adjacent to and inside of the generally rectangular cover sash 130. In one form, it is contemplated that this step may be performed using pushing equipment to push or press the wedge 137 into the sash slot defined by the cover sash 130 and the inner sash 118.

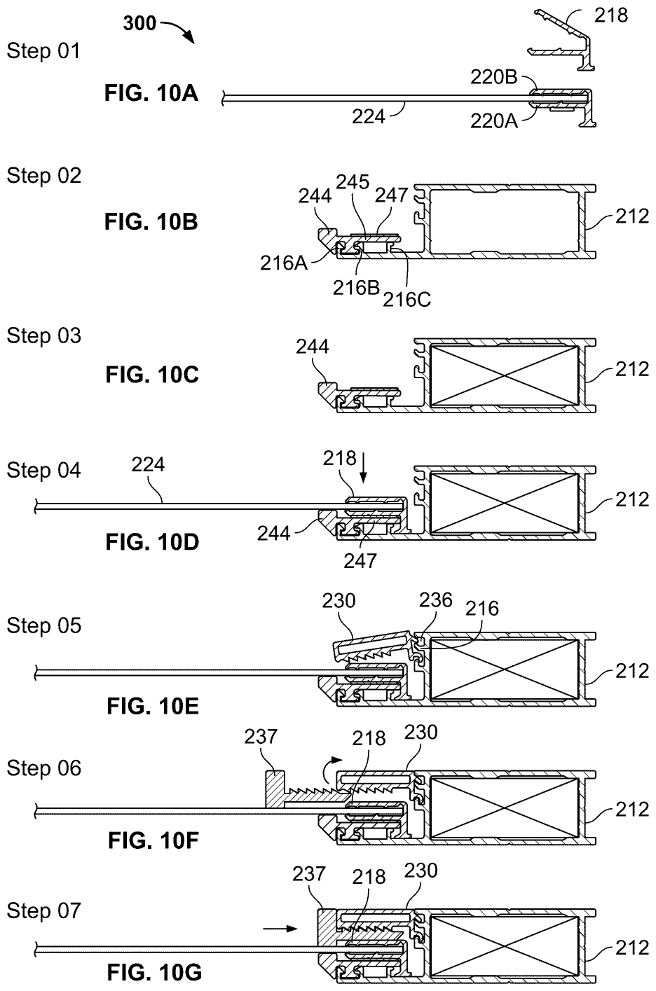

FIGS. 10A, 10B, 10C, 10D, 10E, 10F, and 10G show cross-sectional views of a second frame assembly at various stages, and corresponding steps, of assembly. These figures also collectively illustrate a method 300 of assembly generally including various steps. FIGS. 10A, 10B, 10C, 10D, 10E, 10F, and 10G correspond to the below Steps 1-7, respectively. It is generally contemplated that the second frame assembly is a variation of the first frame assembly 100 described above. The description of the screen security system 10, frame assembly 100, and components thereof are incorporated herein, but differences are noted and described below. Reference numerals for the components are included below for ease of reference and understanding. Also, it should be understood that, in some forms, these assembly steps may be performed in a different order, some steps may be omitted or modified, and other steps may be added. Again, in one preferred form, it is generally contemplated that most or all of the steps are conducted by automated or semi-automated assembly. In other forms, however, some of the steps may be performed manually by individuals.

In step 1 (FIG. 10A), a sheet of mesh or infill 224 is obtained, and then, an inner sash 218 engages the mesh/infill 224 in which two legs 220A and 220B of the inner sash 218 are sandwiched about an end of the mesh/infill 224. The inner sash 218 is generally similar to inner sash 118, but with, at least, one difference. As can be seen, the inner sash 218 does not include serrations/teeth on an outer wall. In one form, it is contemplated that a robot arm may be used to hold the inner sash 218 in position relative to the mesh/infill 224, while a clinch and rivet device (or an individual) applies a fastener to fasten the inner sash 218 to the mesh/infill 224.

In step 2 (FIG. 10B), in one preferred form, a wedge seal 244 is inserted into a slot in the outer sash 212 formed by two engagement members 216A and 216B. The wedge seal 244 is generally similar to wedge seal 144 but with, at least, one difference. As can be seen, the wedge seal 244 has an extended tail 245 that may overlie the third engagement member 216C. In one form, a double-sided adhesive 247, such as, for example, double-sided VHB tape, is applied to the extended tail 245 on the side of the wedge seal 244 opposite from the engagement members 216A, 216B, and 216C. In one form, an automatic adhesive tape application machine may be used to apply the adhesive, such as VHB tape, to the top surface of the wedge seal 244. In one form, the automatic adhesive tape application machine may apply an adhesive sealing or double-sided adhesive tape automatically the full length of a strip of the wedge seal 244.

Step 3 of method 300 (FIG. 10C) is generally the same as step 3 of method 200 described above. In step 3, four partial frame assemblies have been formed. Corner fixing fasteners may be used to connect a partial frame assembly to an adjacent one to form a rectangular frame.

Step 4 of method 300 (FIG. 10D) is similar to step 4 of method 300 but with, at least, one difference. In step 4, the combined mesh/infill 224 and inner sash 218 (of step 1) is attached to the partially-assembled rectangular frame (of step 3). However, in this form, it is generally contemplated that an outer wall of the inner sash 218 is pushed or pressed against the side of the double-sided adhesive 247 that is opposite from the one adhering to the wedge seal 244. Further, in one form, as in method 200, it is contemplated that one or more robot arms, including, for example, a robot arm using a vacuum cup effector, may be utilized in this step (and in other steps). For example, a robot arm using a vacuum cup effector may be used to hold the inner sash 218 and push the inner sash 218 downwardly to engage the outer sash 212 and wedge seal 244.

Steps 5, 6, and 7 of method 300 (FIGS. 10E, 10F, and 10G) are generally the same as steps 5, 6, and 7 of method 200, and the description above is incorporated herein. The wedge 237 is similar to wedge 137 but with, at least, one difference. Wedge 237 only has serrations or teeth on one side (unlike wedge 137, which has serrations or teeth on both a top side and a bottom side). In step 5, the cover sash 230 is inserted between engagement members 236 in a temporary position and orientation. In step 6, the tip of the wedge 237 is inserted between the inner sash 218 and the cover sash 230 to cause the cover sash 230 to rotate upwardly into its final position. In step 7, the wedge 237 is inserted (or impacted) into the space between the inner sash 218 and the cover sash 230.

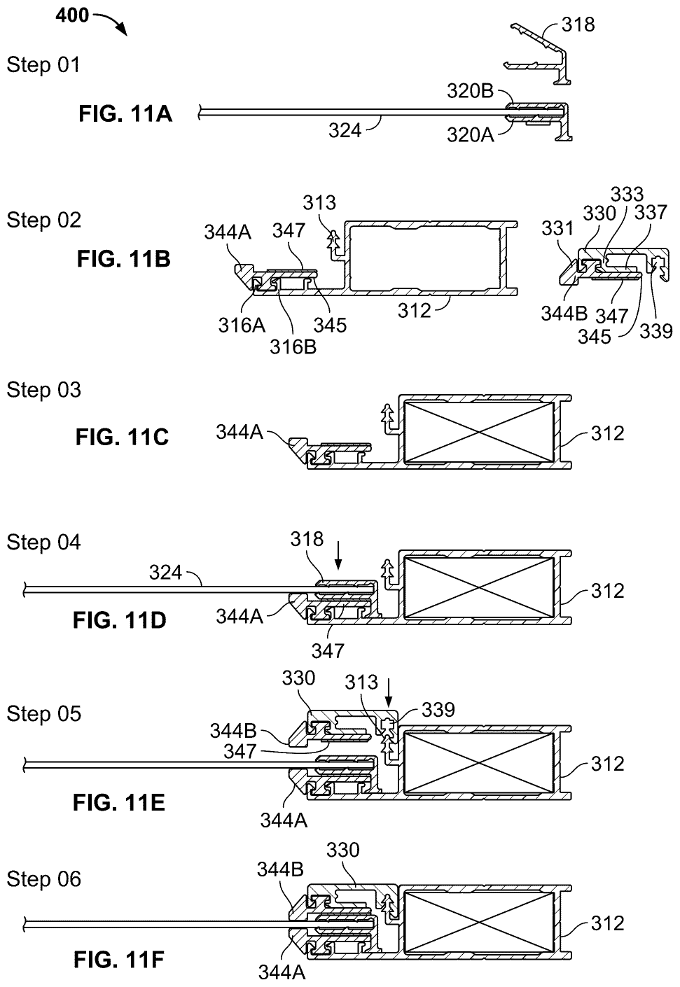

FIGS. 11A, 11B, 11C, 11D, 11E, and 11F show cross-sectional views of a third frame assembly at various stages, and corresponding steps, of assembly. These figures also collectively illustrate a method 400 of assembly generally including various steps. FIGS. 11A, 11B, 11C, 11D, 11E, and 11F correspond to the below Steps 1-6, respectively. It is generally contemplated that the third frame assembly is another variation of the first frame assembly 100 described above. The description of the screen security system 10, frame assembly 100, and components thereof are incorporated herein, but differences are noted and described below. Reference numerals for the components are included below for ease of reference and understanding. Also, it should be understood that, in some forms, these assembly steps may be performed in a different order, some steps may be omitted or modified, and other steps may be added. Again, in one preferred form, it is generally contemplated that most or all of the steps are conducted by automated or semi-automated assembly. In other forms, however, some of the steps may be performed manually by individuals.

Step 1 of the method 400 (FIG. 11A) is generally the same as step 1 of the method 300. In step 1, an inner sash 318 engages the mesh/infill screen or sheet 324 in which two legs 320A and 320B of the inner sash 318 are sandwiched about an end of the mesh/infill 324. The inner sash 318 does not include serrations/teeth on an outer wall. Again, in one form, it is contemplated that a clinch and rivet machine (or an individual) applies a fastener to fasten the inner sash 318 to the mesh/infill 324.

In step 2 (FIG. 11B), in one preferred form, a first wedge seal 344A is inserted into a slot in the outer sash 312 formed by two engagement members 316A and 316B. However, the structure of the outer sash 312 has been modified to include a double-barbed prong 313 (instead of engagement members 116D, 116E, and 116F). As can be seen, the first wedge seal 344A has an extended tail 345. In one form, a double-sided adhesive 347, such as, for example, double-sided VHB tape, is preferably applied to the extended tail 345 on the side of the first wedge seal 344A opposite from the engagement members 316A and 316B.

Also, in step 2 (FIG. 11B), a second wedge seal 344B has been inserted in a cover sash 330. In this form, the structure of the cover sash 330 has been modified relative to the previous version. The cover sash 330 may include two engagement members 331 and 333 that define a slot therebetween for receiving the second wedge seal 344B. It may also include a ledge 337 for supporting the extended tail 345 of the second wedge seal 344B. Further, the cover sash 330 may include a recess 339 that is shaped and configured to receive the double-barbed prong 313 of the outer sash 312. In addition, a double-sided adhesive 347, such as, for example, double-sided VHB tape, is preferably applied to the extended tail 345 on the side of the second wedge seal 344B opposite the ledge 337.

Step 3 of method 400 (FIG. 11C) is generally the same as step 3 of method 200 described above. In step 3, four partial frame assemblies have been formed, and corner fixing fasteners may be used to connect a partial frame assembly to an adjacent one to form a rectangular frame.

Step 4 of method 400 (FIG. 11D) is generally the same as step 4 of method 300 described above. In step 4, the combined mesh/infill 324 and inner sash 318 (of step 1) is attached to the partially-assembled rectangular frame (of step 3). In this form, it is generally contemplated that an outer wall of the inner sash 318 is pushed or pressed against the side of the double-sided adhesive 347 that is opposite from the one adhering to the first wedge seal 344A. Further, as with the other methods 200 and 300, it is contemplated that one or more robot arms may be utilized in this step (and in other steps). For example, a robot arm using a vacuum cup effector may be used to hold the inner sash 318 and push the inner sash 318 downwardly to engage the outer sash 312 and first wedge seal 344A.

In step 5 (FIG. 11E), the cover sash 330 is pushed or pressed downwardly to engage the outer sash 312. More specifically, the cover sash 330 is oriented so that its recess 339 receives the double-barbed prong 313 of the outer sash 312 as the cover sash 330 is pushed downwardly. In addition, the double-sided adhesive 347 on the second wedge seal 344B engages and adheres to the inner sash 318. In one form, it is contemplated that a robot arm using a vacuum cup effector to hold the cover sash 330 may push the cover sash 330 downwardly to engage the outer sash 312.

Step 6 of the method 400 (FIG. 11F) is generally a continuation of step 5. In step 6, the cover sash 330 is pressed into position. In one form, it is contemplated that a vertical press machine and vertical press automation may be used to press the cover sash 330 into position relative to the outer sash 312.

Accordingly, generally speaking, pursuant to various embodiments, systems, apparatuses, and methods are provided herein for a screen system. In one form, the system includes: a plurality of frame assemblies defining a frame, each frame assembly being connected to at least one other frame assembly; and a sheet of infill material secured to the frame. In the system, at least one of the frame assemblies comprises: an outer sash comprising a first sidewall, a second sidewall, and at least one first engagement member, the first sidewall including a retaining portion; a cover sash comprising at least one second engagement member configured to engage the at least one first engagement member such that the cover sash occupies a position opposing the retaining portion of the first sidewall and, in combination with the retaining portion, defines a channel therebetween; and an inner sash disposed in the channel between the retaining portion and the cover sash, the inner sash configured to retain an end of the sheet of infill material.

In some implementations, the system further includes a first wedge disposed, at least in part, between the retaining portion and the sheet of infill material, the first wedge including a first stopper portion extending beyond the first sidewall and engaging the end of the sheet of infill material. In some implementations, the retaining portion comprises a plurality of third engagement members defining a slot configured to receive and retain a portion of the first wedge. In some implementations, the system further includes a second wedge disposed, at least in part, between the cover sash and the sheet of infill material, the second wedge including a second stopper portion extending beyond the cover sash and engaging the end of the sheet. In some implementations, the inner sash comprises two legs configured for receiving and retaining the end of the sheet of infill material therebetween, the screen system further comprising a fastener inserted through the two legs of the inner sash and through the end of the sheet of infill material. In some implementations, the cover sash comprises a first plurality of serrations configured to retain the second wedge and wherein the inner sash comprises a second plurality of serrations configured to retain the second wedge. In some implementations, the second wedge comprises a third plurality of serrations configured for engagement with the first plurality of serrations of the cover sash and comprises a fourth plurality of serrations configured for engagement with the second plurality of serrations of the inner sash. In some implementations, the cover sash defines an outer boundary that is an extension of the second sidewall of the outer sash. In some implementations, the system further comprises adhesive retaining the inner sash to the first wedge and/or the inner sash to the second wedge. In some implementations, the first wedge and the second wedge have the same shape. In some implementations, the first sidewall includes a first base portion extending into the retaining portion and the second sidewall includes a second base portion opposing the first base portion. In some implementations, the infill material comprises a mesh.

In another form, there is provided a method of assembling a screen system. The method includes: providing the sheet of infill material, the outer sash, the cover sash, and the inner sash; attaching the inner sash to an end of the sheet of infill material; pushing the attached inner sash and infill material toward the retaining portion of the first sidewall of the outer sash; engaging the at least one second engagement member of the cover sash with the at least one first engagement member of the outer sash to form the channel in which the inner sash is disposed.

In some implementations, the method may also include inserting a portion of a first wedge into a slot in the retaining portion. In some implementations, the method may also include inserting a tip of a second wedge between the cover sash and inner sash, the insertion causing the cover sash to rotate to a new position. In some implementations, the method may also include pressing the second wedge into a space between the inner sash and the cover sash. In some implementations, in the method, the inner sash comprises two legs; and the step of attaching the inner sash to an end of a mesh and/or other infill sheet comprises: receiving the mesh in a channel defined by the two legs; and applying a fastener through the mesh and through the two legs. In some implementations, the method may further include applying double-sided adhesive to the first wedge to adhere the first wedge to the inner sash and/or to the second wedge to adhere the second wedge to the inner sash. In some implementations, a robot arm is configured to hold the inner sash in position while the infill material is attached to the inner sash. In some implementations, a robot arm with a vacuum cup effector is configured to push the attached inner sash and infill material toward the retaining portion of the first sidewall of the outer sash.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the technological contribution. The actual scope of the protection sought is intended to be defined in the following claims.

What is claimed is:

1. A screen system comprising:
a plurality of frame assemblies defining a frame, each frame assembly being connected to at least one other frame assembly;
a sheet of infill material secured to the frame;
at least one of the frame assemblies comprising:
an outer sash comprising a first sidewall, a second sidewall, and at least one first engagement member, the first sidewall including a retaining portion;
a cover sash comprising at least one second engagement member configured to engage the at least one first engagement member such that the cover sash occupies a position opposing the retaining portion of the first sidewall and, in combination with the retaining portion, defines a channel therebetween; and
an inner sash disposed in the channel between the retaining portion and the cover sash, the inner sash configured to retain an end of the sheet of infill material.

2. The screen system of claim 1, further comprising:
a first wedge disposed, at least in part, between the retaining portion and the sheet of infill material, the first wedge including a first stopper portion extending beyond the first sidewall and engaging the end of the sheet of infill material.

3. The screen system of claim 2, wherein the retaining portion comprises a plurality of third engagement members defining a slot configured to receive and retain a portion of the first wedge.

4. The screen system of claim 3, further comprising:
a second wedge disposed, at least in part, between the cover sash and the sheet of infill material, the second wedge including a second stopper portion extending beyond the cover sash and engaging the end of the sheet.

5. The screen system of claim 4, wherein the inner sash comprises two legs configured for receiving and retaining the end of the sheet of infill material therebetween, the screen system further comprising a fastener inserted through the two legs of the inner sash and through the end of the sheet of infill material.

6. The screen system of claim 5, wherein the cover sash comprises a first plurality of serrations configured to retain the second wedge and wherein the inner sash comprises a second plurality of serrations configured to retain the second wedge.

7. The screen system of claim 6, wherein the second wedge comprises a third plurality of serrations configured for engagement with the first plurality of serrations of the cover sash and comprises a fourth plurality of serrations configured for engagement with the second plurality of serrations of the inner sash.

8. The screen system of claim 1, wherein the cover sash defines an outer boundary that is an extension of the second sidewall of the outer sash.

9. The screen system of claim 4, further comprising adhesive retaining the inner sash to the first wedge and/or the inner sash to the second wedge.

10. The screen system of claim 4, wherein the first wedge and the second wedge have the same shape.

11. The screen system of claim 1, wherein:
the first sidewall includes a first base portion extending into the retaining portion and the second sidewall includes a second base portion opposing the first base portion.

12. The screen system of claim 1, wherein the infill material comprises a mesh.

13. A method of assembling the screen system of claim 1, the method comprising:
providing the sheet of infill material, the outer sash, the cover sash, and the inner sash;
attaching the inner sash to an end of the sheet of infill material;
pushing the attached inner sash and infill material toward the retaining portion of the first sidewall of the outer sash; and
engaging the at least one second engagement member of the cover sash with the at least one first engagement member of the outer sash to form the channel in which the inner sash is disposed.

14. The method of claim 13, further comprising inserting a portion of a first wedge into a slot in the retaining portion.

15. The method of claim 14, further comprising inserting a tip of a second wedge between the cover sash and inner sash, the insertion causing the cover sash to rotate to a new position.

16. The method of claim 15, further comprising pressing the second wedge into a space between the inner sash and the cover sash.

17. The method of claim 13, wherein:
the inner sash comprises two legs; and
the step of attaching the inner sash to an end of a mesh and/or other infill sheet comprises:
receiving the mesh in a channel defined by the two legs; and
applying a fastener through the mesh and through the two legs.

18. The method of claim 16, further comprising:
applying double-sided adhesive to the first wedge to adhere the first wedge to the inner sash and/or to the second wedge to adhere the second wedge to the inner sash.

19. The method of claim 13, wherein a robot arm is configured to hold the inner sash in position while the infill material is attached to the inner sash.

20. The method of claim 13, wherein a robot arm with a vacuum cup effector is configured to push the attached inner sash and infill material toward the retaining portion of the first sidewall of the outer sash.
